(19) United States
(12) Patent Application Publication
(10) Pub. No.: US 2009/0311421 A1
(43) Pub. Date: Dec. 17, 2009

(54) DEVICE AND PROCESS FOR VARNISHING METALLIC ELEMENTS

(76) Inventor: Silvio Maria Trevisan, Verona (IT)

Correspondence Address: GOTTLIEB RACKMAN & REISMAN PC, 270 MADISON AVENUE, 8TH FLOOR, NEW YORK, NY, 10016-0601, US

(21) Appl. No.: 11/995,972

(22) PCT Filed: Dec. 7, 2005
(86) PCT No.: PCT/EP2005/013101

§ 371 Date: Jan. 17, 2008

(30) Foreign Application Priority Data
Jul. 20, 2005 (IT) MI2005A001388

(51) Int. Cl. B05D 1/12; B05B 9/00; B05B 5/025

(52) U.S. Cl. 427/180; 118/308; 118/621

(57) ABSTRACT

The device for varnishing metallic elements (1) comprises support means of the metallic elements (1) to be varnished through powdered varnish and dispensing means of the powdered varnish through a screen printing plate (5), foreseeing rotation means (6) of the screen printing plate about a rotation axis and translation means (7) of the rotation means (6) to give said screen printing plate (5) a roto-translation motion with respect to the metallic elements (1) to be varnished. The process for varnishing metallic elements through powdered varnish consists of keeping each metallic element in suspended position during the deposition on one or more of its faces of at least one layer of powdered varnish after having been made to pass through a screen printing plate.

The present invention refers to a device and process for varnishing metallic elements.

As known, currently there are numerous devices for varnishing metallic elements and in particular aluminium profiles on the market.

Amongst these devices, to decorate a metallic element, there are those that use a flat screen printing plate having a predetermined design to reproduce on the profile, for example the so-called “wood effect”.

The powdered varnish, normally of a different colour to that of the partially polymerised powdered varnish that defines the base layer that covers the metallic profile, is passed through the screen printing plate so as to make the desired decoration on the profile.

The second layer of varnish partially penetrates into the first layer of varnish, in liquid state from the heating carried out, and binds with it. Finally, the profile is subjected to a temperature suitable for allowing the first layer of varnish to complete polymerisation and allowing the second layer (although there could also be a third and fourth layer) to polymerise.

The passage of the varnish through the matrix is normally carried out with a squeegee, or equivalent member, which tends to deform the screen printing plate with all the drawbacks that derive from this situation.

Therefore, during the deposition of the second (or third or fourth) layer of varnish the matrix is taken into contact with the profiles so as to avoid this drawback. Then, thanks to the fact that the first layer of varnish that covers the profile is taken into liquid state through administering of temperature, it fixes onto metallic profile and then the second layer of varnish fixes onto it. This allows the profile to be subsequently manipulated without problems to send it to the final firing oven or else it allows it to be rotated to carry out the decoration on the other faces and, above all, allows the matrix to be placed on it, as stated, without ruining the decoration by doing so.

This decoration system, therefore, as can easily be seen from the above, has the drawback of being rather complex, of having a low hourly production, of needing specialised manpower, with an increase in the cost of the end product.

The technical task proposed of the present invention is, therefore, that of making a device and process for the surface treatment of metallic elements, in particular but not necessarily varnishing, which allows the aforementioned technical drawbacks of the prior art to be eliminated.

In this technical task, a purpose of the invention is to make a device and process for varnishing metallic elements that has low costs and little use of a specialised workforce.

Another purpose of the invention is to make a device and process for varnishing metallic elements that is simplified both structurally and procedurally whilst still ensuring an end product quality that is the same as if not better than that of conventional systems. Yet another purpose of the invention is to make a device and process for varnishing metallic elements that ensures a constant high quality over time since it is not subject to the individual ability of the workers.

The last but not least purpose of the invention is to make a device and process for varnishing metallic elements that allows energy consumption to be optimised avoiding superfluous preheating and cooling of the profile while the decoration is being carried out.

This technical task, as well as these and other purposes, according to the present invention, are accomplished by making a device for varnishing metallic elements comprising support means of said metallic elements to be varnished through powdered varnish and dispensing means of said powdered varnish through a screen printing plate, characterised in that it comprises rotation means of said screen printing plate about a rotation axis and translation means of said rotation means to give said screen printing plate a roto-translation motion with respect to said metallic elements to be varnished.

Also forming the object of the present invention is a process for surface treating metallic elements, characterised in that during treatment each metallic element is peripherally held in a position of suspension so that its entire surface can freely be reached by the treatment product, and is peripherally biased in traction so as to at least partially compensate the displacement that can be caused by its preferably horizontal arrangement.

Also forming the object of the present invention is, in particular, a process for varnishing metallic elements through powdered varnish, characterised in that it consists of keeping each metallic element in suspended position during the deposition on one or more of its faces of at least one layer of powdered varnish after having been made to pass through a screen printing plate.

Other characteristics of the present invention are defined, moreover, in the subsequent claims.

Further characteristics and advantages of the invention shall become clearer from the description of a preferred but not exclusive embodiment of a device for varnishing metallic elements according to the finding, illustrated for indicating and not limiting purposes in the attached drawings, in which:

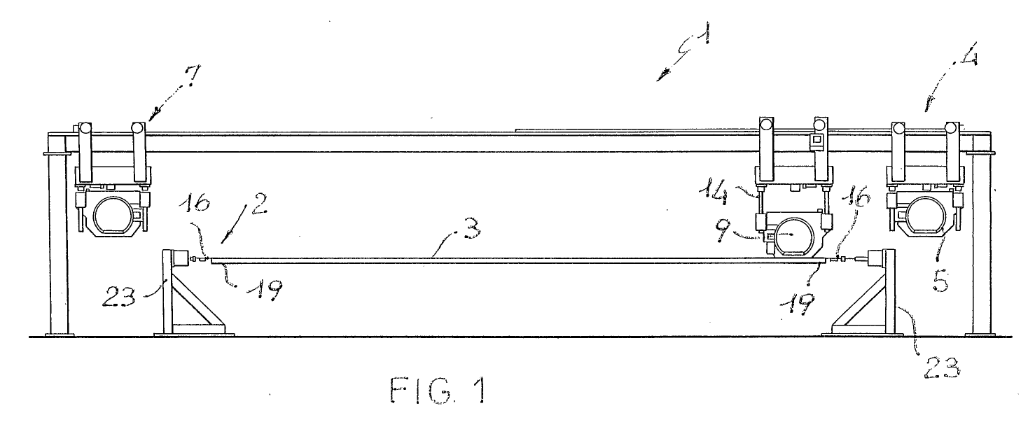

FIG. 1 is a top side view of the device according to the finding;

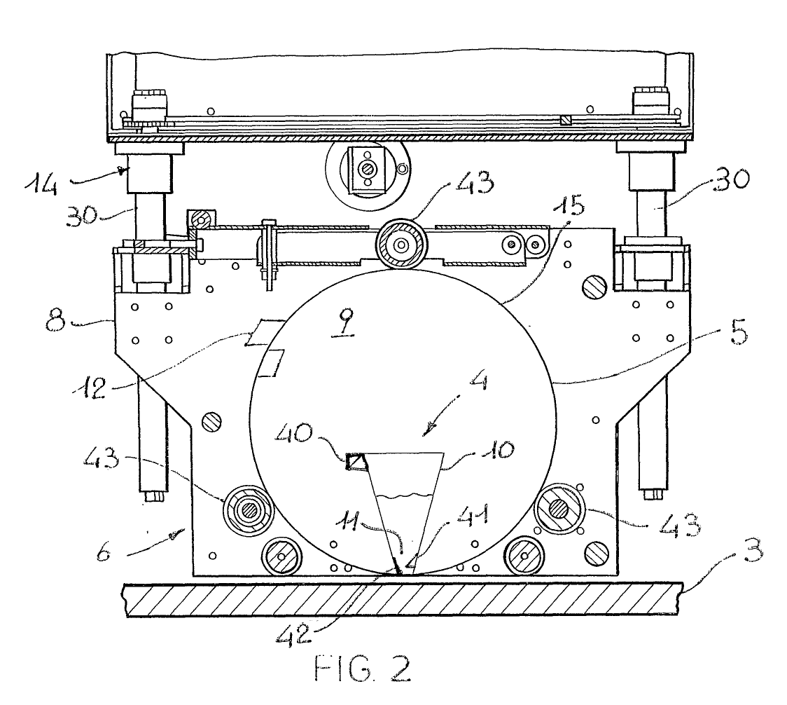

FIG. 2 is a partially sectioned top side view of the cylindrical body according to the finding;

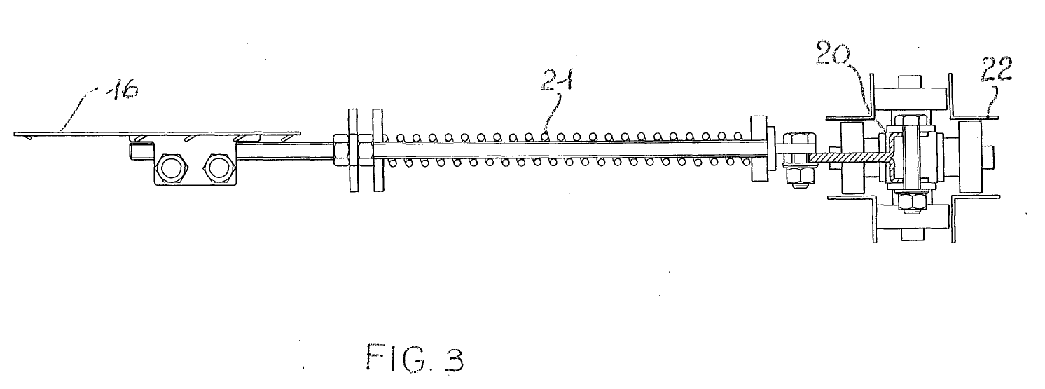

FIG. 3 is a top side view of the support means according to the finding;

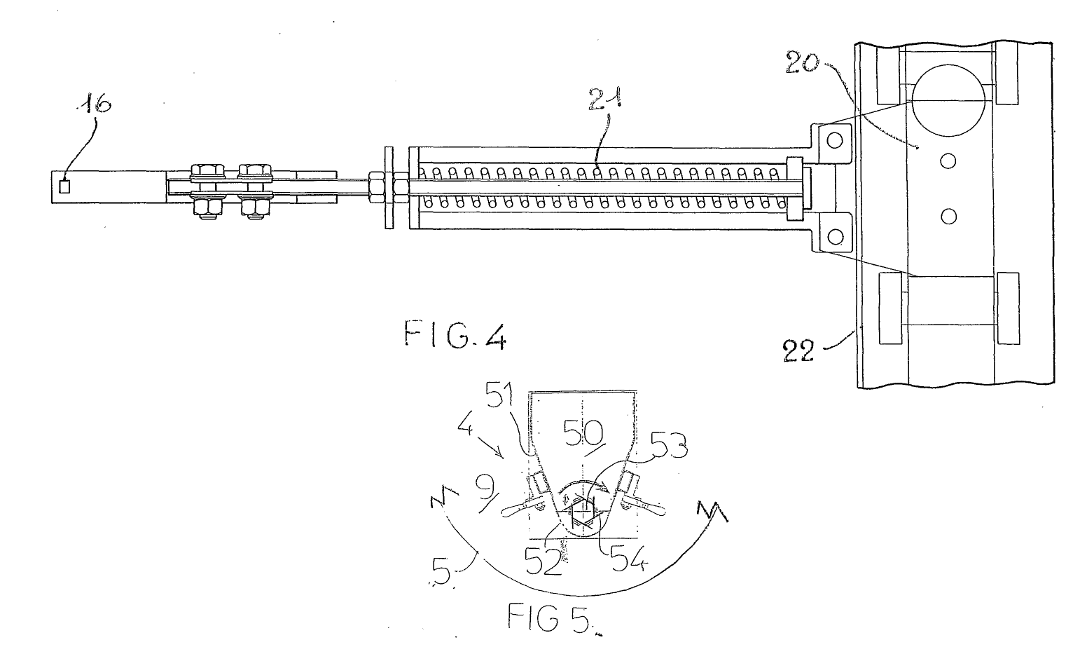

FIG. 4 is a plan view from above of the support means according to the finding; and

FIG. 5 is a front view of a different embodiment of the dispensing means of the powdered varnish support means according to the present invention.

With reference to the quoted figures, the device and process for varnishing metallic elements, wholly indicated with reference numeral 1, comprises support means, wholly indicated with 2, of the metallic elements to be varnished through powdered varnish. Such metallic elements can, for example, be aluminium profiles that must be decorated with the so-called “wood effect”. The device also comprises dispensing means, wholly indicated with 4, of the powdered varnish through a screen printing plate 5 and rotation means 6 of said screen printing plate about a rotation axis.

There are also translation means, wholly indicated with 7, suitable for making the rotation means 6 rotate so as to give the screen printing plate 5 a roto-translation motion with respect to the metallic elements to be varnished 3.

The screen printing plate 5, advantageously, has a cylinder-shaped surface that has a plurality of predetermined passage openings according to the decoration that is intended to be made on the profile.

The matrix is supported by two circular shoulders 8 with it defining a cylindrical body closed at the sides so as to allow powdered varnish to come out exclusively from the matrix.

In particular, the dispensing means 4 are arranged inside the cylindrical body 9 and comprise at least one hopper 10 having a dispensing mouth 11 of the powdered varnish. The mouth 11 is adjustable, through a regulator 40, according to the type of varnish so as to obtain its homogeneous and calibrated deposition on the inner surface of the matrix.

Advantageously, the dispensing mouth is fixed with respect to the matrix and preferably, but not necessarily, has a first rigid lip 41, distanced from the matrix, and a second flexible lip 42 in contact with said matrix (or vice-versa) and suitable for carrying out the passage of the powdered varnish through the plurality of openings.

Advantageously, the peripheral speed of the cylindrical body can be less than, equal to or greater than its translation speed so as to be able to modify the deposition method of the powdered varnish according to the type of decoration wished to be obtained.

Regarding this, in a different preferred embodiment illustrated in FIG. 5, the dispensing means 4 comprise a powdered varnish distributor arranged inside the cylindrical body 9 and having adjustment means (not shown) of the distribution rate correlated to the difference between the peripheral speed and the translation speed of the screen printing plate 5.

The distributor 50 comprises a casing 51 with yielding holes 52, in which there is a rotatable shaft 53 controlled by the adjustment means, perimetrically equipped with paddles 54 suitable for moving the powdered varnish towards the yielding holes 52.

The shaft 53, as well as the rotation, is able to carry out a translation suitable for moving the paddles 54 from an operating state of tangency to the inner profile of the casing 51 to a rest position away from the inner profile of the casing 51.

Basically, if one wishes to vary a design maintaining an ideal thickness of deposited powder it is necessary to associate a change in distribution rate of the distributor 50 with the change in peripheral and/or translation speed of the matrix 5.

Hypothesising as an example a constant peripheral speed of the matrix 5, to “lengthen” the printed design it is necessary to increase the translation speed of the matrix 5, but if one wishes to maintain the same thickness of deposited powder it is also necessary to increase the amount of powder dispensed per unit time and therefore the rotation speed of the paddles 54.

Now with reference once again to all of the figures, it should be noted that the powdered varnish does not necessarily have to be suitably electrostatically charged since it advantageously acquires the electrostatic charge necessary for adhesion to the surface of the metallic elements when passing through said screen printing plate.

In order to allow the varnish to change colour and to keep it in optimal conditions of use there are means 12 for cleaning the inside and outside of the matrix from powdered varnish.

The device also comprises displacement means 14 of the cylindrical body 9, for example fluid dynamic pistons 30, capable of moving the cylindrical body 9 along a direction substantially perpendicular to its direction of translation.

In this way it is possible to optimally distance the matrix from the face of the profile to be decorated according to its size and its configuration always keeping a fixed distance along the entire extension of the profile also in its central flexing zone. In particular, the smaller the distance of the matrix, so long as it is absolutely prevented from making contact with the profiles, the better it is.

For example, experimental tests have demonstrated that a distance of 1.5-2 mm gives a good result.

Preferably, to maintain the ideal distance between the matrix 5 and the profile during treatment, means (not shown) for detecting the progression of the surface to be treated can be foreseen, suitable for causing the displacement means 14 to move.

In particular, such detection means can comprise a first and at least a second photocell for detecting the presence of metallic elements, positioned at different heights in the bottom area of the circular shoulders 8 and downstream of the dispensing means 4 in the direction in which the matrix 5 advances.

The first and second photocell in particular cause the displacement means 14 to move only when their detection states are concordant.

For example, the first and the second photocell are placed at heights distanced by a few millimetres.

When the profile of the surface to be decorated is between the photocells, one of them shall give a positive detection signal whereas the other shall give a negative reading signal: no command to move the displacement means 14 shall be triggered by this condition since the profile is the correct distance from the matrix 5.

When the profile of the surface to be decorated is above or below both of the photocells, respectively, they shall concordantly give respective positive and negative detection signals: these conditions trigger a command to move the displacement means 14 so as to respectively, raise or lower the matrix 5 until it restores the correct distance of the profile, indicated by the signals coming from the photocells that once again become discordant.

Of course, the detection means can also be of another type.

The rotation means 6 comprise guides 15 formed on the shoulders 8 of the cylindrical body 9 that engage on respective support wheels 43 circumferentially equally spaced apart so as to allow the balanced rotation of the cylindrical body 9 about its own axis.

At least one of said wheels is motorised, for example with an electric motor reducer, to give the cylindrical body a suitable rotation speed for the working requirements.

The support means of the metallic elements comprise a hook member 16 engaged with a seat present on each end 19 of each of said metallic elements.

The hook member is supported by a holding member, such as a trolley 20, in contrast with and by the action of elastic means, for example a spring 21.

The presence of the spring, in addition to compensating the thermal dilations of the profile, also allows its flexing to be contained. The trolley 20 is able to slide along guides 22 of a support plane 23 of the metallic elements.

The spring 21, moreover, is connected to the trolley 20 and hinged to the hook member 16 so that it rotates about its own axis to allow the rotation of the profiles to decorate the different faces, also thanks to the fact that each profile is suspended or rather distanced from the support plane 23.

Advantageously, means (not shown) for counterthrusting the holding member 20 are also foreseen, which oppose the elastic means 21, to displace the hook member 16 towards the suitable position for the hooking and unhooking operation of the profile.

The counterthrusting means comprise a fluid dynamic piston carried by the holding member 20.

Basically, the fluid dynamic piston displaces the hooking member 16, overcoming the reaction of the spring 21, towards the centre of the support plane and thus allows the hooking/unhooking of the profile.

The system for moving the metallic elements to be treated can also be different to that illustrated previously relative to the sector of the powdered varnish.

For example, the trolley 20 can be replaced by any equivalent displacement means.

Of course, in the case of a plant, it is possible to operatively use many cylindrical bodies for the sequential deposition of the powdered varnish, for example of different colours, to make decorations with many layers on the metallic elements.

In particular, it is possible to associate with each cylindrical body the treatment of a different surface of the metallic elements that are rotated when passing from one cylinder to the next so that they are orientated making it face the surface to be treated.

In the case of a single treatment cylindrical body, on the other hand, the rotation of the metallic elements preferably takes place during the return stroke of the cylindrical body.

With the technical solution described above it is possible to carry out the undercoat varnishing of the profile (with or without the use of the cylindrical screen printing plates, but for example also with conventional systems with spray guns) and then carry out the decoration of the profile through the cylindrical screen printing plate depositing one or more layers of powdered varnish onto the undercoat that are then polymerised in an oven.

In a different solution the layers of powdered varnish that form the undercoat and/or the decoration can be deposited one on top of the other at room temperature on the profile, i.e. without any administration of temperature.

Thanks to the fact that each profile is decorated in suspended horizontal position it is possible to rotate it about its own axis and decorate all of its faces that will not be ruined either by the contact of the matrix that always remains distanced or by the contact with the support plane.

Thereafter, the profile can be taken into the oven and the layers of powdered varnish that are in granular state can be polymerised simultaneously.

Also forming the object of the present patent for an invention is a process for surface treating metallic elements during which each metallic element is peripherally held in a position of suspension so that its entire surface can freely be reached by the treatment product, and is peripherally biased in traction so as to at least partially compensate the displacement that can be caused by its preferably horizontal arrangement.

Of course, the fact that the metallic elements are preferably suspended horizontally allows them to be treated easily without interruptions along their entire surface without it being ruined.

The metallic elements subjected to suitable traction keep their geometry unchanged: this on the one hand allows the profiles not to undergo unhelpful oscillations when rotated about an axis to hold another of their surfaces, and on the other hand allows them to be subjected without complications to many repeatable treatments of the same type or even of different types.

In particular, the process, applied to the industrial field of powder varnishing metallic elements, has the substantial advantage of keeping each metallic element in suspended horizontal position during the deposition on one of its faces of at least one layer of powdered varnish.

The powdered varnish is advantageously passed through a screen printing plate that never touches the profile but always remains distanced from it.

In brief, onto each metallic element a first layer of powdered varnish is deposited on which at least a second layer of powdered varnish is deposited.

In a preferred solution the metallic element is not subjected to any predetermined temperature greater than room temperature until all of the required layers of powdered varnish have been deposited.

Thereafter, all of the layers of powdered varnish are polymerised simultaneously.

During the deposition of the layers of powdered varnish, the faces of the metallic element are kept perfectly horizontal and the screen printing plate carries out a roto-translation movement to a predetermined distance from said metallic element. After the decoration of a face it is possible to rotate the profile and sequentially decorate the other faces without the danger of ruining the decoration whilst it is still formed from powdered varnish.

In practice, it has been noted how the device and process for varnishing metallic elements according to the invention are particularly advantageous for being able to offer the user a very high quality of decoration in an extremely simple way but with high productivity.

The device for varnishing metallic elements thus conceived can undergo numerous modifications and variants, all covered by the inventive concept; moreover, all of the details can be replaced by technically equivalent elements.

In practice, the materials used, as well as the sizes, can be whatever according to the requirements and the state of the art.

1. Device for varnishing metallic elements comprising
support means of said metallic elements to be varnished through powdered varnish and
dispensing means of said powdered varnish through a screen printing plate, characterised in that it comprises rotation means of said screen printing plate about a rotation axis and translation means of said rotation means to give said screen printing plate a roto-translation motion with respect to said metallic elements to be varnished.

2. Device according to claim 1, characterised in that said screen printing plate has a cylinder-shaped surface and a plurality of predetermined openings for the passage of said powdered varnish extending along said cylinder-shaped surface.

3. Device according to claim 1, characterised in that, said matrix is supported by two circular shoulders defining with it a cylindrical body closed at the side.

4. Device according to claim 3, characterised in that said dispensing means are arranged inside said cylindrical body and comprise at least one hopper having an adjustable mouth for dispensing said powdered varnish for its homogeneous and calibrated deposition on the inner surface of said matrix.

5. Device according to claim 4, characterised in that said dispensing mouth is fixed with respect to said matrix.

6. Device according to claim 4, characterised in that said mouth has a first lip with different physical characteristics to those of a second lip.

7. Device according to claim 3, characterised in that said dispensing means are arranged inside said cylindrical body and comprise a distributor of powdered varnish having means for adjusting the rate of distribution in a manner correlated to the difference between the peripheral speed and the translation speed of said screen printing plate.

8. Device according to claim 7, characterised in that said distributor comprises a casing with yielding holes, in which there is a shaft controlled in rotation, perimetrically equipped with paddles suitable for moving said powdered varnish towards said yielding holes.

9. Device according to claim 1, characterised in that said powdered varnish acquires electrostatic charge as it passes through said screen printing plate.

10. Device according to claim 1, characterised in that it comprises means for cleaning the inside and outside of said matrix from powdered varnish.

11. Device according to claim 1, characterised in that it comprises displacement means of said cylindrical body along a direction substantially perpendicular to said direction of translation.

12. Device according to claim 3, characterised in that it comprises means for detecting the progression of the surface to be treated, suitable for making said displacement means move so that said matrix follows said surface to be treated substantially maintaining an optimal distance as it advances along said direction of translation.

13. Device according to claim 12, characterised in that said detection means comprise a first and at least a second photocell for detecting the presence of said metallic elements, positioned at different heights in the bottom area of said circular shoulders and downstream of said dispensing means in the advancing direction along said direction of translation, said first and at least a second photocell causing said displacement means to move only when their detection states are concordant.

14. Device according to claim 13, characterised in that said rotation means comprise guides formed on said shoulders of said cylindrical body engaged on respective rotating support wheels of said cylindrical body, at least one of said wheels being motorised for the transmission of the motion to said cylindrical body.

15. Device according to claim 1, characterised in that said support means of said metallic elements comprise a hook member engaged with a seat present on each end of each of said metallic elements and a holding member in contrast to and by the action of elastic means, of said hook member.

16. Device according to claim 1, characterised in that said holding member is able to slide along guides of a support plane of said metallic elements.

17. Device according to claim 15, characterised in that said hook member is able to slide about its own axis with respect to said holding member.

18. Device according to claim 17, characterised in that the peripheral speed of said cylindrical body is different to or the same as the translation speed of said cylindrical body.

19. Device according to claim 1, characterised in that said support means hold said metallic elements in suspension to allow them to freely rotate about their own axes at the same time as the rotation of said hook member.

20. Device according to claim 15, characterised in that it has counterthrusting means of said holding member, which oppose said elastic means, for the displacement of said hook member towards the suitable position—for the hooking and unhooking operation of each of said metallic elements.

21. Device according to claim 20, characterised in that said counterthrusting means comprise a fluid dynamic piston.

22. Device according to claim 1, characterised in that it comprises many cylindrical bodies for the sequential deposition of said powdered varnish on said metallic elements.

23. Process for surface treating metallic elements, characterised in that during treatment each metallic element is peripherally held in a position of suspension so that its entire surface can freely be reached by the treatment product, and is peripherally biased in traction so as to at least partially compensate the displacement that can be caused by its preferably horizontal arrangement.

24. Process for varnishing metallic elements through powdered varnish, characterised in that it consists of keeping each metallic element in suspended position during the deposition on one or more of its faces of at least one layer of powdered varnish after having been made to pass through a screen printing plate.

25. Process according to claim 24 characterised in that on said metallic element a first layer of powdered varnish is deposited on which at least a second layer of powdered varnish is deposited, said metallic element not being subjected to any predetermined temperature above room temperature until all of the required layers of powdered varnish have been deposited, said layers of powdered varnish all being polymerised simultaneously.

26. Process according to claim 24, characterised in that during the deposition of the layers of powdered varnish, said faces of said metallic element are kept perfectly horizontal.

27. Process according to claim 23, characterised in that said matrix has a roto-translation movement with respect to said metallic elements.

28. Process according to claim 23, characterised in that said screen printing plate carries out said roto-translation movement a predetermined distance from said metallic element.
